(19) United States
(12) Patent Application Publication
(10) Pub. No.: US 2015/0207264 A1
(43) Pub. Date: Jul. 23, 2015

(54) Waterproof Connector

(71) Applicant: Japan Aviation Electronics Industry, Limited, Tokyo (JP)

(72) Inventors: Katsumi Arai, Tokyo (JP); Masayuki Kikuchi, Tokyo (JP); Masayuki Nishikata, Tokyo (JP)

(21) Appl. No.: 14/424,010

(22) PCT Filed: Jun. 11, 2013
(86) PCT No.: PCT/JP2013/066071

§ 371 Date: Feb. 25, 2015

(30) Foreign Application Priority Data
Sep. 4, 2012 (JP) 2012-194112

(51) Int. Cl. H01R 13/52; H01R 13/405

(52) U.S. Cl. CPC H01R 13/5202; H01R 13/405

(57) ABSTRACT

A waterproof connector includes a housing that is formed of an insulating resin, and at least one contact that is integrally formed in the housing. The contact has at least one housing fixing unit that is disposed in a middle portion in the longitudinal direction of the contact and is embedded in the housing and fixed thereto, and a pair of overhanging portions that are respectively disposed at both ends of the housing fixing unit and overhang in a direction vertical to a longitudinal direction of the housing fixing unit. A portion of the housing that is in contact with the housing fixing unit is fitted between the pair of overhanging portions.

### TECHNICAL FIELD

The present invention relates to a waterproof connector, particularly to a waterproof connector in which a contact and a housing that is made of insulating resin are formed integrally with each other.

### BACKGROUND ART

In recent years, there is a strong demand for waterproof function in various electronic devices and accordingly, waterproof connectors having waterproof property have been under development for the purpose of use in connection with an external device.

One example of such waterproof connectors is a connector in which a housing made of insulating resin is formed to be integral with a conductive contact to contain the same therein by, for example, insert molding. Owing to the integral molding, a surface of the contact adheres at the portion embedded in the housing to the insulating resin making up the housing and this prevents water from entering the inside of the connector from the outside of the connector through a boundary portion between the housing and the contact.

In general, however, a metal material making up the contact and a resin material making up the housing are different in thermal expansion coefficient from each other and therefore, when the connector is exposed to a high temperature environment during a soldering process in mounting the connector onto a circuit board of an electronic device for example, owing to the different expansion amount between the contact and the insulating resin, the insulating resin adhering to the surface of the contact may be separated therefrom. Once the insulating resin is separated, a gap is generated between the surface of the contact and the insulating resin and water may disadvantageously enter the inside of the connector through the gap even after the temperature falls to ambient temperature.

Aside from that, when a counter connector is fitted to a connector in which a contact and a housing are formed integrally with each other, the counter connector may be forcibly fitted in a direction oblique to the fitting axis, which is so-called “ill fitting,” and a high stress may be applied to the portion between the housing and the contact. In this case, again, insulating resin making up the housing may be separated from a surface of the contact, which damages waterproof property of the connector.

To cope with it, for instance, Patent Literature 1 discloses a waterproof connector in which a tiny gap generated between a housing 1 and a contact 2 that are formed integrally with each other is filled with a waterproof sealant 3 to thereby improve waterproof property, as shown in FIG. 23.

### CITATION LIST

### Patent Literature

Patent Literature 1: JP 2012-134130 A

### SUMMARY OF INVENTION

### Technical Problems

However, in order to fill the waterproof sealant 3 in the tiny gap between the housing 1 and the contact 2, a complex apparatus is required for carrying out complex steps in which the connector is put in a liquid container retaining a liquid waterproof sealant to be immersed in the waterproof sealant after the contact 2 is fixed to the housing 1 by molding; the whole liquid container in this state is transported into a closed container of a decompression processing apparatus; and the pressure of the inside of the closed container is decreased by a vacuum pump to thereby evacuate the air present in the gap between the housing 1 and the contact 2 so that the gap is filled with the waterproof sealant in place of the air.

Furthermore, since the waterproof sealant adheres also to surfaces, including a contact portion, of the contact 2 through the immersion of the whole connector in the waterproof sealant, after the gap between the housing 1 and the contact 2 is filled with the waterproof sealant, the waterproof sealant adhering to the contact portion needs to be washed away by an ultrasonic washer or the like.

The present invention is aimed at solving the above problems of the prior art and providing a waterproof connector exhibiting excellent waterproof function without special treatment for improving waterproof property following integral molding of a housing with a contact.

### Solution to Problems

A waterproof connector according to the present invention comprises a housing made of insulating resin, and at least one contact with which the housing is formed to be integral, the contact including one or more housing fixing portions provided at a middle portion of the contact in a length direction of the contact and embedded in the housing to be fixed to the housing, and a pair of overhanging portions separately provided at opposite ends of the housing fixing portion to overhang in a direction perpendicular to a length direction of the housing fixing portion, wherein the housing has a portion in contact with the housing fixing portion and the portion of the housing is sandwiched between the pair of overhanging portions.

The pair of overhanging portions may respectively overhang over an entire periphery of the contact with respect to the length direction of the housing fixing portion. Otherwise, the pair of overhanging portions may respectively overhang over part of a periphery of the contact in the direction perpendicular to the length direction of the housing fixing portion.

The housing fixing portions may be aligned along the length direction of the contact and the pair of overhanging portions are provided at opposite ends of each of the housing fixing portions.

Preferably, the pair of overhanging portions respectively have overhanging surfaces each connected to an end of the housing fixing portion and the portion of the housing in contact with the housing fixing portion being sandwiched between the overhanging surfaces. The pair of overhanging surfaces may extend in the direction perpendicular to the length direction of the housing fixing portion or in a direction inclined with respect to the length direction of the housing fixing portion.

The pair of overhanging portions may be embedded together with the housing fixing portion in the housing. Otherwise, the pair of overhanging portions may be disposed outside of the housing with at least a part of the overhanging surfaces being in contact with an outer surface of the housing.

Preferably, the contact has at its one end a contact portion formed to come into contact with a contact of a counter connector and at its another end a board attachment portion formed to be attached to a board, and wherein the housing fixing portion is provided between the contact portion and the board attachment portion.

It may be constructed that each of the pair of overhanging portions has a same area as that of the contact portion or the board attachment portion in a cross section perpendicular to the length direction of the contact whereas the housing fixing portion is smaller in cross-sectional area than each of the pair of overhanging portions. Otherwise, each of the housing fixing portion and the pair of overhanging portions may have a same area as that of the contact portion or the board attachment portion in a cross section perpendicular to the length direction of the contact and the pair of overhanging portions may be formed at the opposite ends of the housing fixing portion by bending the contact.

Preferably, fine irregularities are formed at a surface of the housing fixing portion for increasing an anchoring effect between the housing fixing portion and the housing.

The contact may be composed of a flat plate member or a pin member having a circular cross section.

### Advantageous Effects of Invention

According to the present invention, the contact has the pair of overhanging portions separately provided at the opposite ends of the housing fixing portion embedded in the housing, and the housing has a portion in contact with the housing fixing portion, the portion of the housing being sandwiched between the pair of overhanging portions. Therefore, even though special treatment for improving waterproof property is not performed after integral molding of the housing with the contact, it is possible to exhibit excellent waterproof function.

### BRIEF DESCRIPTION OF DRAWINGS

FIG. 1 is a perspective view showing a waterproof connector according to Embodiment 1 of the present invention when viewed obliquely from the front.

FIG. 2 is a perspective view showing the waterproof connector according to Embodiment 1 when viewed obliquely from the rear.

FIG. 3 is a cross-sectional view showing the waterproof connector according to Embodiment 1.

FIG. 4 is a perspective view showing a contact used in the waterproof connector according to Embodiment 1.

FIG. 5 is a cross-sectional view showing an embedment portion of the contact embedded in a housing of the waterproof connector according to Embodiment 1.

FIG. 6 is a cross-sectional view showing contact portions of the contacts accommodated in grooves of the housing.

FIG. 7 is a cross-sectional view showing the state in which the waterproof connector according to Embodiment 1 is mounted on a board.

FIG. 8 is a cross-sectional view showing a waterproof connector according to Embodiment 2.

FIG. 9 is a perspective view showing a contact used in the waterproof connector according to Embodiment 2.

FIG. 10 is a perspective view showing a contact used in a waterproof connector according to Embodiment 3.

FIG. 11 is a perspective view showing a contact used in a waterproof connector according to a modification of Embodiment 3.

FIG. 12 is a perspective view showing a contact used in a waterproof connector according to another modification of Embodiment 3.

FIG. 13 is a cross-sectional view showing a waterproof connector according to Embodiment 4.

FIG. 14 is a perspective view showing a contact used in the waterproof connector according to Embodiment 4.

FIG. 15 is a cross-sectional view showing a waterproof connector according to Embodiment 5.

FIG. 16 is a perspective view showing a contact used in the waterproof connector according to Embodiment 5.

FIG. 17 is a perspective view showing a contact used in a waterproof connector according to a modification of Embodiment 5.

FIG. 18 is a cross-sectional view showing a waterproof connector according to Embodiment 6.

FIG. 19 is a perspective view showing a contact used in the waterproof connector according to Embodiment 6.

FIG. 20 is a cross-sectional view showing a waterproof connector according to Embodiment 7.

FIG. 21 is a cross-sectional view showing an embedment portion of a contact embedded in a housing of the waterproof connector according to Embodiment 7.

FIG. 22 is a cross-sectional view showing a housing fixing portion of a contact used in a waterproof connector according to Embodiment 8.

FIG. 23 is a partial cross-sectional view showing the structure of a conventional waterproof connector.

### DESCRIPTION OF EMBODIMENTS

Embodiments of the present invention will be described below based on the appended drawings.

### Embodiment 1

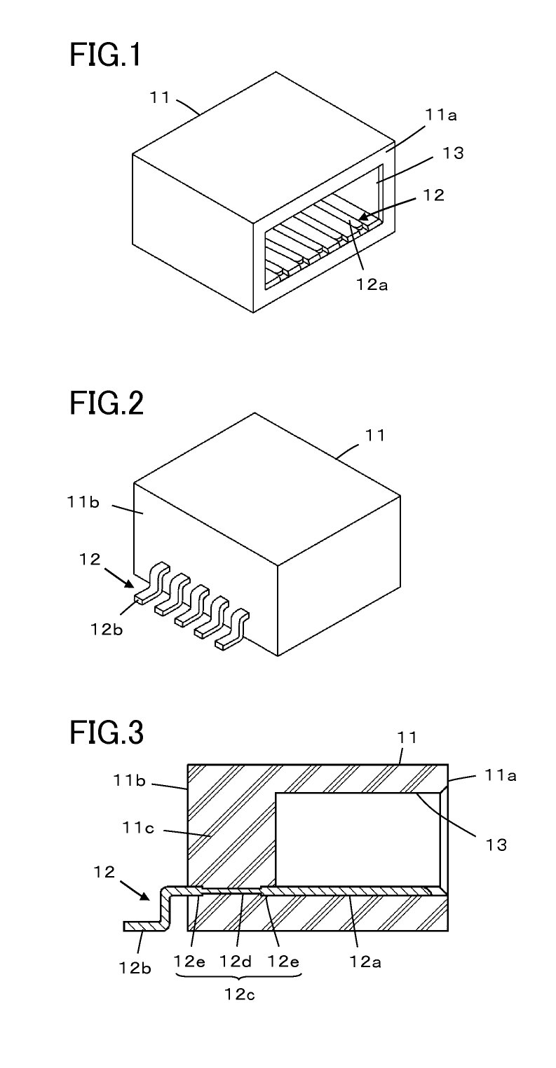

FIG. 1 shows the structure of a waterproof connector according to Embodiment 1 of the present invention. The waterproof connector includes a housing 11 having a cuboid outer shape and a plurality of contacts 12 fixed to the housing 11. A counter-connector receiving portion 13 having a concave shape is formed in the housing 11 to open at a front surface 11a of the housing 11 and a contact portion 12a provided at the front end of each contact 12 is placed inside the counter-connector receiving portion 13 of the housing 11. The counter-connector receiving portion 13 of the housing 11 is a space for receiving a counter connector to be fitted with the waterproof connector according to Embodiment 1. On the other hand, a board attachment portion 12b provided at the rear end of each contact 12 extends out of the housing 11 from a rear surface llb of the housing 11 as shown in FIG. 2.

As shown in FIG. 3, the housing 11 has a rear wall 11c present between the innermost portion of the counter-connector receiving portion 13 and the rear surface llb of the housing 11. The contacts 12 penetrate the rear wall 11c of the housing 11 and are thereby supported by the housing 11. The contact portions 12a of the contacts 12 placed inside the counter-connector receiving portion 13 of the housing 11 are portions to be in contact with the corresponding contacts of the counter connector fitted in the counter-connector receiving portion 13, while the board attachment portions 12b extending outward from the rear surface 11b of the housing 11 are portions used for attaching the contacts 12 to the board on which the waterproof connector is to be mounted and for establishing the conduction.

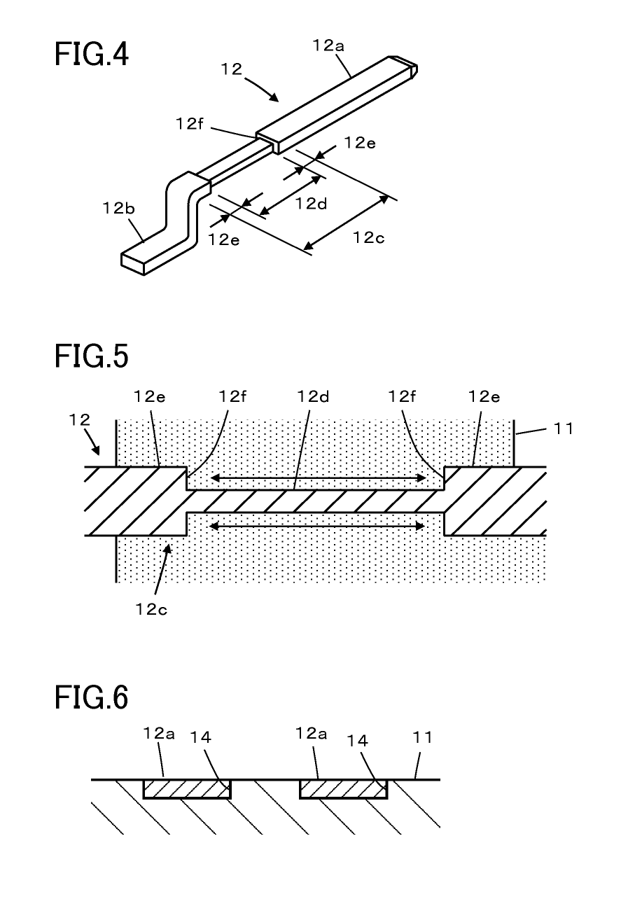

Each of the contacts 12 is composed of a flat plate member and has an embedment portion 12c formed between the contact portion 12a and the board attachment portion 12b as shown in FIG. 4. The embedment portion 12c is a portion to be embedded in the rear wall 11c when the contact penetrates the rear wall 11c of the housing 11 as shown in FIG. 3. A housing fixing portion 12d is formed at the middle of the embedment portion 12c and a pair of overhanging portions 12e are separately provided at the opposite ends of the housing fixing portion 12d. The housing fixing portion 12d and the pair of overhanging portions 12e constitute the embedment portion 12c.

The pair of overhanging portions 12e are continuous with the contact portion 12a and the board attachment portion 12b of the contact 12, respectively. The overhanging portions 12e each have the same area as that of the contact portion 12a or the board attachment portion 12b of the contact 12 in a cross section perpendicular to the length direction of the contact 12, whereas the housing fixing portion 12d is smaller in cross-sectional area than the overhanging portion 12e. In other words, the housing fixing portion 12d is constricted relative to the overhanging portions 12e provided at the opposite ends of the housing fixing portion. Each of the overhanging portions 12e overhangs in the direction perpendicular to the length direction of the housing fixing portion 12d over the entire periphery of the contact.

A difference in level is formed at the boundary part between either of the overhanging portions 12e and the housing fixing portion 12d. The overhanging portions 12e each have an overhanging surface 12f connected to an either end of the housing fixing portion 12d and extending in the direction perpendicular to the length direction of the housing fixing portion 12d.

The housing 11 is made of, for example, a resin material having insulation property and formability and the contacts 12 are made of a metal material having conductivity.

The housing 11 is formed to be integral with the contacts 12 by setting the contacts 12 in a mold which is not shown, closing the mold, pouring molten insulating resin material into the mold and cooling the mold, whereby the waterproof connector as shown in FIGS. 1 to 3 is manufactured.

Owing to the integral molding of the housing 11 with the contacts 12, the insulating resin making up the housing 11 adheres to the surfaces of the embedment portions 12c of the contacts 12 embedded in the rear wall 11c of the housing 11. At this time, since the housing fixing portion 12d of the contact 12 has a smaller area in a cross section perpendicular to the length direction of the contact 12 than the area of either of the overhanging portions 12e at the opposite ends of the housing fixing portion, of the insulating resin making up the housing 11, the portion in contact with the surfaces of the housing fixing portion 12d is sandwiched between the pair of overhanging portions 12e as shown in FIG. 5. More specifically, the insulating resin is sandwiched between the overhanging surfaces 12f of the pair of overhanging portions 12e.

The insulating resin material making up the housing 11 is generally has a greater thermal expansion coefficient than that of the metal material making up the contacts 12 and therefore, when the waterproof connector is exposed to a high temperature environment in, for example, soldering the board attachment portion 12b of the contact 12 onto a wiring pattern of a circuit board, the insulating resin in contact with the housing fixing portion 12d of the contact 12 tries to expand more than the housing fixing portion 12d as indicated by arrows in FIG. 5.

However, the insulating resin is sandwiched between the overhanging surfaces 12f of the pair of overhanging portions 12e and this configuration prevents the amount of expansion of the insulating resin in contact with the surfaces of the housing fixing portion 12d from becoming larger than the amount of expansion of the housing fixing portion 12d. As a result, the separation of the insulating resin from the surfaces of the housing fixing portion 12d due to a stress applied between the surfaces of the housing fixing portion 12d and the insulating resin in the length direction of the housing fixing portion 12d is avoided, thus maintaining the adhesion between the surfaces of the housing fixing portion 12d and the insulating resin.

Therefore, a gap is not generated between the surfaces of the housing fixing portion 12d and the insulating resin, so that excellent waterproof function is exhibited between the housing 11 and the contacts 12.

Furthermore, even when a counter connector is forcibly fitted in a direction oblique to the fitting axis, which is so-called “ill fitting,” in fitting operation of the connector with the counter connector, owing to the insulating resin sandwiched between the overhanging surfaces 12f of the pair of overhanging portions 12e, a stress is inhibited from being concentrated at a portion between the surfaces of the housing fixing portion 12d and the insulating resin, thus avoiding the separation of the insulating resin from the surfaces of the housing fixing portion 12d. Therefore, excellent waterproof function is maintained.

A plurality of grooves 14 are formed at the bottom of the inside of the counter-connector receiving portion 13 of the housing 11 to correspond to the contacts 12 as shown in FIG. 6 and the contact portions 12a of the contacts 12 are respectively accommodated in the corresponding grooves 14. Therefore, even when a stress is applied to a contact portion 12a of any of the contacts 12 in a direction toward an adjacent contact 12 due to some cause at the time of, for example, fitting with the counter connector, the corresponding groove 14 limits movement of the contact portion 12a of the contact 12, thereby preventing defects such as a short-circuit between adjacent contacts 12.

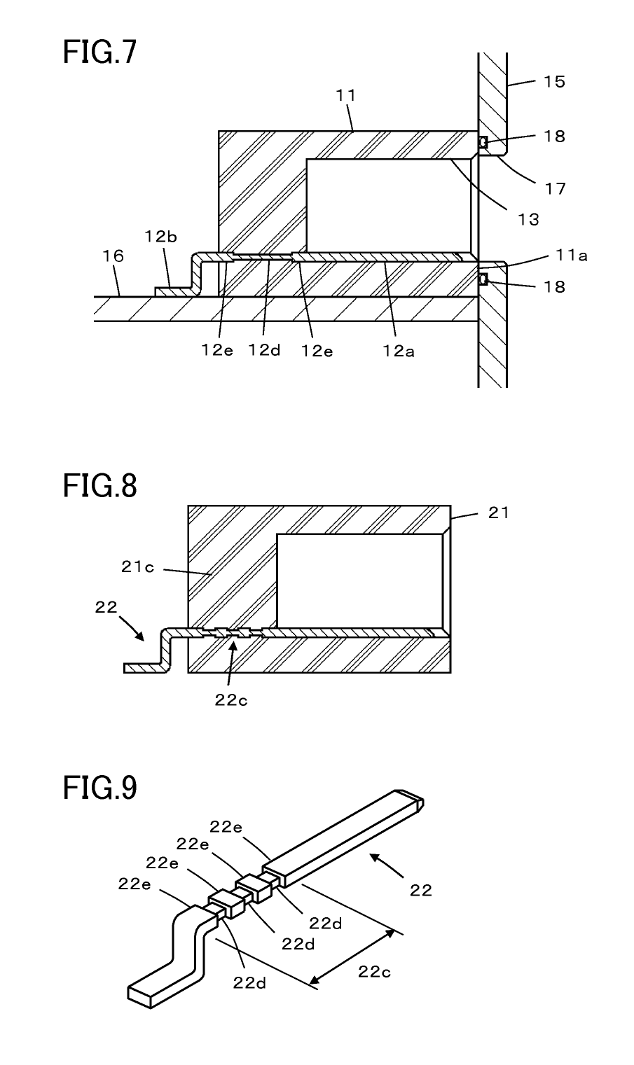

As shown in FIG. 7, for instance, the waterproof connector according to Embodiment 1 is mounted for use on a board 16 disposed in a casing 15 of an electrical device such as a mobile phone. An opening 17 is formed at the casing 15 to correspond to the counter-connector receiving portion 13 of the housing 11 and a gasket 18 is disposed along the periphery of the opening 17 to seal between an inner surface of the casing 15 and the front surface 11a of the housing 11.

The configuration described above prevents moisture existing outside the casing 15 from entering the inside of the casing 15 through the counter-connector receiving portion 13 of the housing 11 because the adhesion is maintained between the surfaces of the housing fixing portion 12d of the contact 12 and the insulating resin making up the rear wall 11c of the housing 11, while the gasket 18 serves to keep moisture from entering the inside of the casing 15 through a gap between the casing 15 and the housing 11, thus making it possible to achieve waterproof function.

As described above, in the waterproof connector according to Embodiment 1, the housing 11 is formed to be integral with the contact 12 in which the overhanging portions 12e are separately provided at the opposite ends of the housing fixing portion 12d whereby the insulating resin in contact with the housing fixing portion 12d is sandwiched between the pair of overhanging portions 12e. As a result, even though special treatment for improving waterproof property is not performed after integral molding of the housing 11 with the contacts 12, it is possible to avoid the separation of the insulating resin from the surfaces of the housing fixing portion 12d which may occur at high temperature during, for example, a soldering process and for the ill fitting in which a counter connector is forcibly fitted in an oblique direction, thus maintaining the adhesion between the housing fixing portion 12d and the insulating resin and exhibiting excellent waterproof function.

It should be noted that while the five contacts 12 are disposed in the housing 11 in FIGS. 1 and 2, the number of the contacts 12 is not limited to five and may be one to four or six or more.

In addition, while the housing 11 of the waterproof connector has, for instance, a height of 4 mm and a depth from the front surface 11a to the rear surface 11b of 5 mm and has the rear wall 11c with a thickness of about 1 mm to about 2 mm, the size of the housing 11 is not limited thereto.

### Embodiment 2

FIG. 8 shows a waterproof connector according to Embodiment 2. A housing 21 made of insulating resin and a contact 22 are formed integrally with each other and an embedment portion 22c of the contact 22 is embedded in a rear wall 21c of the housing 21 in the same manner as the waterproof connector in Embodiment 1.

However, as shown in FIG. 9, three housing fixing portions 22d are aligned at the embedment portion 22c of the contact 22, and overhanging portions 22e are formed at the opposite ends of each of the housing fixing portions 22d. Each of the overhanging portions 22e has a larger area in a cross section perpendicular to the length direction of the contact 22 than the area of each of the housing fixing portions 22d and overhangs in the direction perpendicular to the length direction of the housing fixing portions 22d over the entire periphery of the contact.

Since the contact 22 as described above and the housing 21 are formed integrally with each other, the insulating resin making up the housing 21 adheres to the surfaces of the embedment portion 22c of the contact 22 while the insulating resin in contact with the surfaces of each of the housing fixing portions 22d is sandwiched between the overhanging portions 22e disposed at the opposite ends of the relevant housing fixing portion 22d. Therefore, even when the waterproof connector is exposed to a high temperature environment during, for example, a soldering process in which the connector is soldered to a circuit board, the amount of expansion of the insulating resin in contact with the surfaces of the housing fixing portions 22d is prevented from becoming larger than the amount of expansion of the housing fixing portions 22d. Furthermore, even when a counter connector is forcibly fitted in a direction oblique to the fitting axis, a stress is inhibited from being concentrated at a portion between the surfaces of the housing fixing portions 22d and the insulating resin. Thus, the separation of the insulating resin from the surfaces of the housing fixing portions 22d is avoided and excellent waterproof function is exhibited.

In Embodiment 2, the three housing fixing portions 22d are aligned at the embedment portion 22c of the contact 22 and therefore, the length of one housing fixing portion 22d is reduced. Accordingly, an expanding force of the insulating resin corresponding to one housing fixing portion 22d at high temperature can be suppressed to a lower level. Furthermore, even with the reduced length of one housing fixing portion 22d, the three housing fixing portions 22d, as a whole, can adhere to the insulating resin with a wide area. Therefore, it is possible to effectively avoid the separation of the insulating resin from the housing fixing portions 22d which may occur at high temperature and during the ill fitting, thus improving waterproof function.

The number of the housing fixing portions 22d at the embedment portion 22c is not limited to three and may be two or four or more.

### Embodiment 3

While in Embodiments 1 and 2 described above, the overhanging portion 12e or 22e of the contact 12 or 22 overhangs over the entire periphery of the contact in the direction perpendicular to the length direction of the housing fixing portion 12d or 22d, the invention is not limited thereto and the overhanging portion may overhang over part of the periphery of the contact in the direction perpendicular to the length direction of the housing fixing portion.

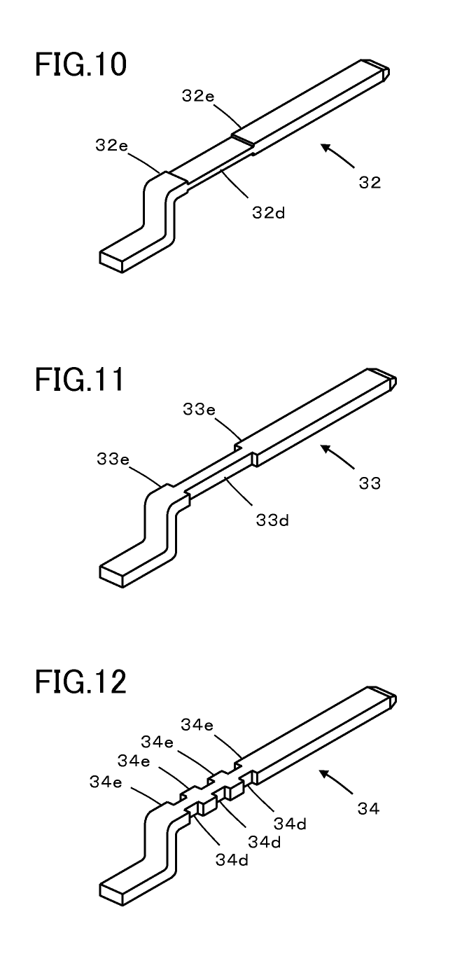

For instance, as shown in FIG. 10, a pair of overhanging portions 32e are separately formed at the opposite ends of a housing fixing portion 32d of a contact 32 composed of a flat plate member so as to overhang from the housing fixing portion 32d in the thickness direction of the flat plate member, and the housing is formed to be integral with the contact 32 so that the housing fixing portion 32d and the pair of overhanging portions 32e are embedded in the housing. With this configuration, the insulating resin making up the housing adheres to the surfaces of the housing fixing portion 32d and those of the overhanging portions 32e while the insulating resin in contact with the surfaces of the housing fixing portion 32d facing in the thickness direction of the housing fixing portion 32d is sandwiched between the pair of overhanging portions 32e, thereby improving waterproof function similarly to Embodiments 1 and 2.

Alternatively, as shown in FIG. 11, a pair of overhanging portions 33e may be separately formed at the opposite ends of a housing fixing portion 33d of a contact 33 composed of a flat plate member so as to overhang from the housing fixing portion 33d in the width direction of the flat plate member. The housing is formed to be integral with the contact 33 so that the housing fixing portion 33d and the pair of overhanging portions 33e are embedded in the housing. Also with this configuration, the insulating resin making up the housing adheres to the surfaces of the housing fixing portion 33d and those of the overhanging portions 33e while the insulating resin in contact with the surfaces of the housing fixing portion 33d facing in the width direction of the housing fixing portion 33d is sandwiched between the pair of overhanging portions 33e, thereby improving waterproof function.

Still alternatively, as shown in FIG. 12, the configuration may be employed in which a plurality of housing fixing portions 34d are aligned at a contact 34 composed of a flat plate member and overhanging portions 34e are separately formed at the opposite ends of each of the housing fixing portions 34d so as to overhang from the housing fixing portion 34d in the width direction of the flat plate member. The housing is formed to be integral with the contact 34 so that the housing fixing portions 34d and the overhanging portions 34e are embedded in the housing. With this configuration, again, the insulating resin making up the housing adheres to the surfaces of the housing fixing portions 34d and those of the overhanging portions 34e while the insulating resin in contact with the surfaces of each of the housing fixing portions 34d facing in the width direction of the housing fixing portions 34d is sandwiched between the overhanging portions 34e disposed at the opposite ends of the relevant housing fixing portion 34d, thereby improving waterproof function.

While in the contact 34 shown in FIG. 12, the three housing fixing portions 34d are aligned, the number of the housing fixing portions 34d may be two or four or more.

Yet still alternatively, also with the configuration in which a plurality of housing fixing portions are aligned and a pair of overhanging portions are formed at the opposite ends of each of the housing fixing portions so as to overhang from the housing fixing portion in the thickness direction of the flat plate member as with the contact 32 shown in FIG. 10, a waterproof connector having excellent waterproof function can be obtained.

### Embodiment 4

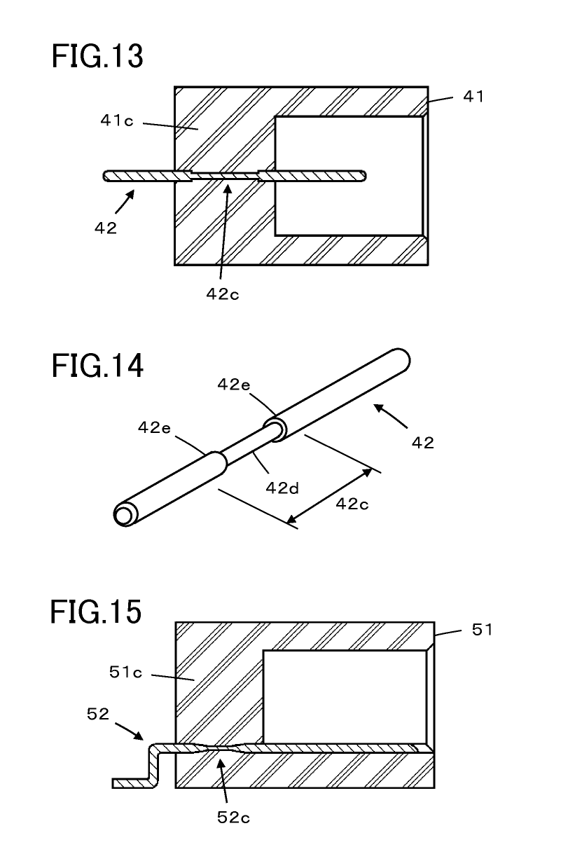

FIG. 13 shows a waterproof connector according to Embodiment 4. A housing 41 made of insulating resin and a contact 42 are formed integrally with each other and an embedment portion 42c of the contact 42 is embedded in a rear wall 41c of the housing 41.

However, the contact 42 is composed of not a flat plate member but a pin member having a circular cross section as shown in FIG. 14. A housing fixing portion 42d having a circular cross section is formed at the embedment portion 42c of the contact 42, and overhanging portions 42e having a circular cross section larger in diameter than that of the housing fixing portion 42d are separately formed at the opposite ends of the housing fixing portion 42d.

Also with this configuration, the insulating resin making up the housing 41 adheres to the surfaces of the embedment portion 42c of the contact 42 while the insulating resin in contact with the outer peripheral surface of the housing fixing portion 42d is sandwiched between the pair of overhanging portions 42e, thereby improving waterproof function similarly to Embodiments 1 to 3.

The overhanging portions 42e preferably overhang in the direction perpendicular to the length direction of the housing fixing portion 42d over the entire periphery of the contact but may overhang over part of the periphery of the contact in the direction perpendicular to the length direction of the housing fixing portion 42d.

### Embodiment 5

While in Embodiment 1 described above, the overhanging portions 12e of the contact 12 each have an overhanging surface 12f extending in the direction perpendicular to the length direction of the housing fixing portion 12d, the overhanging surface need not necessarily extend in the direction perpendicular to the length direction of the housing fixing portion and may extend in a direction inclined with respect to the length direction of the housing fixing portion.

FIG. 15 shows a waterproof connector according to Embodiment 5. A housing 51 made of insulating resin and a contact 52 are formed integrally with each other and an embedment portion 52c of the contact 52 is embedded in a rear wall 51c of the housing 51.

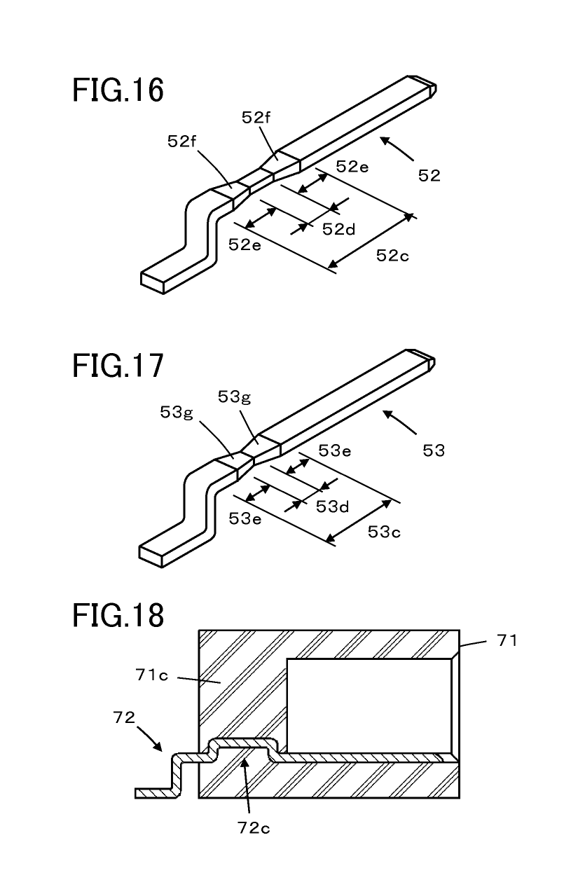

As shown in FIG. 16, a housing fixing portion 52d having a flat plate shape or a prismatic shape is formed at the middle of the embedment portion 52c of the contact 52 and a pair of overhanging portions 52e are separately formed at the opposite ends of the housing fixing portion 52d to overhang in the direction perpendicular to the length direction of the housing fixing portion 52d over the entire periphery of the contact. Each of the overhanging portions 52e has overhanging surfaces 52f extending in directions inclined with respect to the length direction of the housing fixing portion 52d. In other words, the overhanging surfaces 52f of the overhanging portion 52e each constitute an inclined surface connected to a surface of the housing fixing portion 52d.

Since the contact 52 as described above and the housing 51 are formed integrally with each other, the insulating resin making up the housing 51 adheres to the surfaces of the embedment portion 52c of the contact 52 while the insulating resin in contact with the surfaces of the housing fixing portion 52d is sandwiched between the overhanging surfaces 52f of the pair of overhanging portions 52e. The overhanging surfaces 52f overhang more in the direction perpendicular to the length direction of the housing fixing portion 52d with increasing distance from the housing fixing portion 52d in the length direction of the housing fixing portion 52d. Therefore, the amount of expansion of the insulating resin in contact with the surfaces of the housing fixing portion 52d is prevented from becoming larger than the amount of expansion of the housing fixing portion 52d at high temperature during, for example, a soldering process while a stress is inhibited from being concentrated at a portion between the surfaces of the housing fixing portion 52d and the insulating resin during the ill fitting, thus avoiding the separation of the insulating resin from the surfaces of the housing fixing portion 52d. Consequently, excellent waterproof function can be exhibited similarly to Embodiment 1.

Also in Embodiments 2 to 4, the overhanging surfaces of the overhanging portions may be formed to extend in directions inclined with respect to the length direction of the housing fixing portion as with Embodiment 5.

While the contact 52 shown in FIG. 16 is configured so that the housing fixing portion 52d of flat plate shape or prismatic shape is formed between the pair of inclined overhanging portions 52f, as in a contact 53 shown in FIG. 17, a pair of inclined surfaces 53g may abut each other without a portion of flat plate shape or prismatic shape.

In the contact 53, the portion where the pair of inclined surfaces 53g abut each other as well as the vicinity thereof is defined as a housing fixing portion 53d. Overhanging portions 53e are separately formed at the opposite ends of the housing fixing portion 53d to overhang in the direction perpendicular to the length direction of the housing fixing portion 53d and each include an overhanging surface composed of a part of the inclined surface 53g. The housing fixing portion 53d and the pair of overhanging portions 53e constitute an embedment portion 53c.

Even when the contact 53 as described above and the housing 51 are formed integrally with each other, the insulating resin making up the housing adheres to the surfaces of the embedment portion 53c of the contact 53 while the insulating resin in contact with the surfaces of the housing fixing portion 53d is sandwiched between the pair of overhanging portions 53e, thereby improving waterproof function.

While the inclined surfaces 53g may be flat as shown in FIG. 17, surfaces of other shapes such as arc-shaped surfaces and spherical surfaces may also be applied.

### Embodiment 6

In Embodiment 1 described above, the pair of overhanging portions 12e of the contact are respectively formed of portions continuous with the contact portion 12a and the board attachment portion 12b of the contact 12 and each have the same area as that of the contact portion 12a or the board attachment portion 12b of the contact 12 in a cross section perpendicular to the length direction of the contact 12, and the housing fixing portion 12d is smaller in cross-sectional area than the overhanging portion 12e, the contact portion 12a and the board attachment portion 12b. However, the invention is not limited thereto.

FIG. 18 shows a waterproof connector according to Embodiment 6. A housing 71 made of insulating resin and a contact 72 are formed integrally with each other and an embedment portion 72c of the contact 72 is embedded in a rear wall 71c of the housing 71.

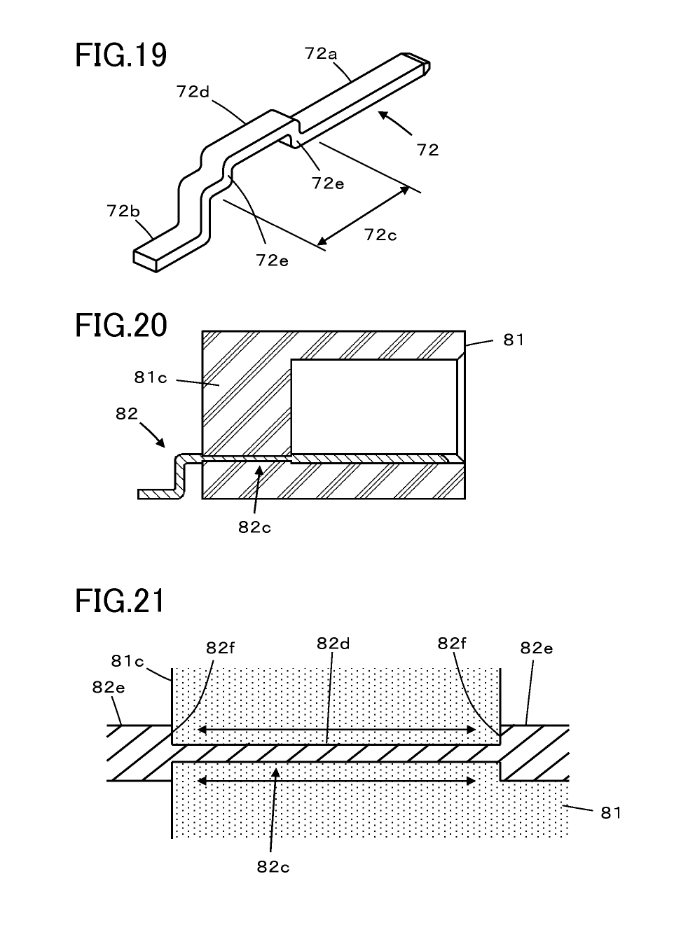

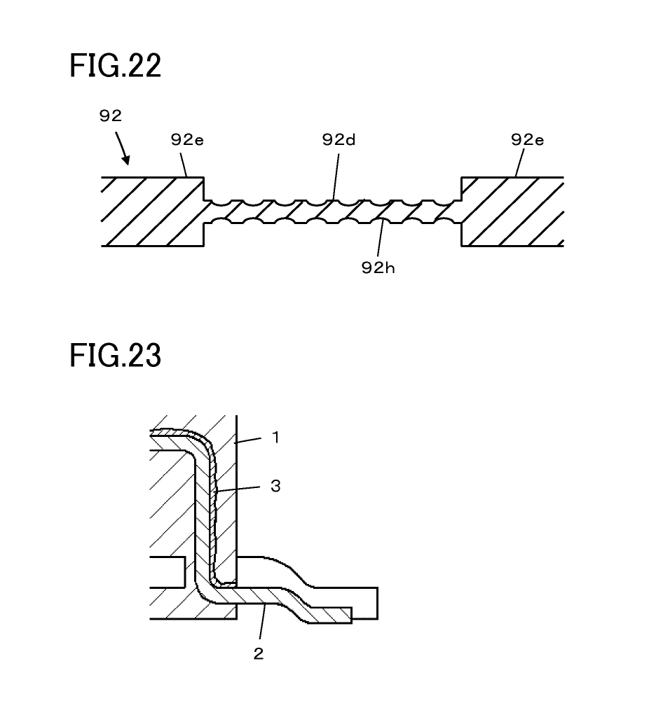

The contact 72 is formed by folding a flat plate member having a uniform cross sectional area from a contact portion 72a through a board attachment portion 72b in a cross section perpendicular to the length direction of the contact 72 as shown in FIG. 19.

A housing fixing portion 72d is formed at the middle of the embedment portion 72c of the contact 72. The flat plate member making up the contact 72 is folded in the same direction at the opposite ends of the housing fixing portion 72d to thereby form overhanging portions 72e that overhang in the direction perpendicular to the length direction of the housing fixing portion 72d. The embedment portion 72c includes the pair of overhanging portions 72e as well as the housing fixing portion 72d.

Since the contact 72 as described above and the housing 71 are formed integrally with each other, the insulating resin making up the housing 71 adheres to the surfaces of the embedment portion 72c of the contact 72 while the insulating resin in contact with the surface of the housing fixing portion 72d facing in the direction in which the overhanging portions 72e are folded is sandwiched between the pair of overhanging portions 72e, whereby the waterproof connector having excellent waterproof function can be obtained.

### Embodiment 7

While in Embodiments 1 to 6 described above, the overhanging portions formed at the opposite ends of the housing fixing portion of the contact are defined, together with the housing fixing portion, as the embedment portion and embedded in the rear wall of the housing, the overhanging portions need not necessarily be embedded in the housing.

FIG. 20 shows a waterproof connector according to Embodiment 7. A housing 81 made of insulating resin and a contact 82 are formed integrally with each other and an embedment portion 82c of the contact 82 is embedded in a rear wall 81c of the housing 81.

As shown in FIG. 21, the contact 82 has a housing fixing portion 82d and a pair of overhanging portions 82e separately formed at the opposite ends of the housing fixing portion 82d to overhang in the direction perpendicular to the length direction of the housing fixing portion 82d, and the embedment portion 82c is composed solely of the housing fixing portion 82d. In other words, the housing fixing portion 82d directly constitutes the embedment portion 82c.

The overhanging portions 82e formed at the opposite ends of the housing fixing portion 82d respectively have overhanging surfaces 82f extending in the direction perpendicular to the length direction of the housing fixing portion 82d and are disposed outside the housing 81 with the overhanging surfaces 82f being in contact with the outer surfaces of the housing 81.

Also with this configuration, owing to the integral molding of the housing 81 with the contacts 82, the insulating resin making up the housing 81 adheres to the surfaces of the embedment portion 82c, i.e., the housing fixing portion 82d, of the contact 82 embedded in the rear wall 81c of the housing 81 while the portion of the insulating resin that is in contact with the surfaces of the housing fixing portion 82d is sandwiched between the overhanging surfaces 82f of the pair of overhanging portions 82e.

Accordingly, even when the waterproof connector is exposed to a high temperature environment during, for example, soldering the connector to a circuit board and the insulating resin in contact with the housing fixing portion 82d tries to greatly expand as indicated by arrows in FIG. 21, since the insulating resin is sandwiched between the overhanging surfaces 82f of the pair of overhanging portions 82e, the amount of expansion of the insulating resin in contact with the surfaces of the housing fixing portion 82d is prevented from becoming larger than the amount of expansion of the housing fixing portion 82d in the length direction of the housing fixing portion 82d. Therefore, the separation between the surfaces of the housing fixing portion 82d and the insulating resin is avoided and excellent waterproof function is exhibited between the housing 81 and the contact 82.

Furthermore, even when the ill fitting is performed in which a counter connector is forcibly fitted in a direction oblique to the fitting axis, owing to the insulating resin sandwiched between the overhanging surfaces 82f of the pair of overhanging portions 82e, a stress is inhibited from being concentrated at a portion between the surfaces of the housing fixing portion 82d and the insulating resin, thus avoiding the separation of the insulating resin from the surfaces of the housing fixing portion 82d and maintaining excellent waterproof function.

While the overhanging surfaces 82f extending in the direction perpendicular to the length direction of the housing fixing portion 82d are wholly in contact with the outer surfaces of the housing 81 in FIG. 21, the same effects can be obtained by forming overhanging surfaces formed of inclined surfaces like the overhanging surfaces 52f in Embodiment 5 and embedding part of the overhanging portions in the housing 81 so that part of the overhanging surfaces is in contact with the outer surfaces of the housing 81.

### Embodiment 8

In Embodiments 1 to 7 described above, fine irregularities 92h may be formed at surfaces of a housing fixing portion 92d of a contact 92. Alternatively, the surfaces of the housing fixing portion 92d may be roughened. When the fine irregularities 92h are formed or the roughening is performed, due to the integral molding of the housing with the contact, the anchoring effect is increased with respect to the housing made of the insulating resin and the adhesion between the metal making up the contact 92 and the insulating resin making up the housing is enhanced, thereby more effectively preventing the separation between the surfaces of the housing fixing portion 92d and the insulating resin from occurring and further improving waterproof function.

Such fine irregularities 92h may be formed or the roughening may be performed at, in addition to the surfaces of the housing fixing portion 92d, the surfaces of overhanging portions 92e formed at the opposite ends of the housing fixing portion 92d to thereby enhance the adhesion between the contact 92 and the insulating resin and improve waterproof function.

### REFERENCE SIGNS LIST

1, 11, 21, 41, 51, 71, 81 housing
2, 12, 22, 32, 33, 34, 42, 52, 53, 72, 82, 92 contact
3 waterproof sealant
11a front surface
11b rear surface
11c, 21c, 41c, 51c, 71c, 81c rear wall
12a, 72a contact portion
12b, 72b board attachment portion
12c, 22c, 42c, 52c, 53c, 72c, 82c embedment portion
12d, 22d, 32d, 33d, 34d, 42d, 52d, 53d, 72d, 82d, 92d housing fixing portion
12e, 22e, 32e, 33e, 34e, 42e, 52e, 53e, 72e, 82e, 92e overhanging portion
12f, 52f, 82f overhanging surface
13 counter connector receiving portion
14 groove
15 casing
16 board
17 opening
18 gasket
53g inclined surface
92h fine irregularities

1.-14. (canceled)

15. A waterproof connector comprising:
a housing made of insulating resin; and
at least one contact with which the housing is formed to be integral,
the contact including
one or more housing fixing portions provided at a middle portion of the contact in a length direction of the contact and embedded in the housing to be fixed to the housing; and
a pair of overhanging portions separately provided at opposite ends of the housing fixing portion to overhang in a direction perpendicular to a length direction of the housing fixing portion,
wherein the housing has a portion in contact with the housing fixing portion and the portion of the housing is sandwiched between the pair of overhanging portions.

16. The waterproof connector according to claim 15, wherein the pair of overhanging portions respectively overhang over an entire periphery of the contact with respect to the length direction of the housing fixing portion.

17. The waterproof connector according to claim 15, wherein the pair of overhanging portions respectively overhang over part of a periphery of the contact in the direction perpendicular to the length direction of the housing fixing portion.

18. The waterproof connector according to claim 15, wherein the housing fixing portions are aligned along the length direction of the contact and the pair of overhanging portions are provided at opposite ends of each of the housing fixing portions.

19. The waterproof connector according to claim 15, wherein the pair of overhanging portions respectively have overhanging surfaces each connected to an end of the housing fixing portion and the portion of the housing in contact with the housing fixing portion being sandwiched between the overhanging surfaces.

20. The waterproof connector according to claim 19, wherein the pair of overhanging surfaces extend in the direction perpendicular to the length direction of the housing fixing portion.

21. The waterproof connector according to claim 19, wherein the pair of overhanging surfaces extend in a direction inclined with respect to the length direction of the housing fixing portion.

22. The waterproof connector according to claim 19, wherein the pair of overhanging portions are embedded together with the housing fixing portion in the housing.

23. The waterproof connector according to claim 19, wherein the pair of overhanging portions are disposed outside of the housing with at least a part of the overhanging surfaces being in contact with an outer surface of the housing.

24. The waterproof connector according to claim 15,
wherein the contact has at its one end a contact portion formed to come into contact with a contact of a counter connector and at its another end a board attachment portion formed to be attached to a board, and
wherein the housing fixing portion is provided between the contact portion and the board attachment portion.

25. The waterproof connector according to claim 24, wherein each of the pair of overhanging portions has a same area as that of the contact portion or the board attachment portion in a cross section perpendicular to the length direction of the contact whereas the housing fixing portion is smaller in cross-sectional area than each of the pair of overhanging portions.

26. The waterproof connector according to claim 24, wherein each of the housing fixing portion and the pair of overhanging portions has a same area as that of the contact portion or the board attachment portion in a cross section perpendicular to the length direction of the contact and the pair of overhanging portions are formed at the opposite ends of the housing fixing portion by bending the contact.

27. The waterproof connector according to claim 15, wherein fine irregularities are formed at a surface of the housing fixing portion for increasing an anchoring effect between the housing fixing portion and the housing.

28. The waterproof connector according to claim 15, wherein the contact is composed of a flat plate member or a pin member having a circular cross section.
